(19) United States
(12) Patent Application Publication
(10) Pub. No.: US 2014/0253438 A1
(43) Pub. Date: Sep. 11, 2014

(54) INPUT COMMAND BASED ON HAND GESTURE

(71) Applicants: Dustin L. Hoffman, Cypress, TX (US); Michael Delpier, Houston, TX (US); Wendy S Spurlock, Houston, TX (US)

(72) Inventors: Dustin L. Hoffman, Cypress, TX (US); Michael Delpier, Houston, TX (US); Wendy S Spurlock, Houston, TX (US)

(21) Appl. No.: 14/356,204

(22) PCT Filed: Dec. 23, 2011
(86) PCT No.: PCT/US2011/067079

§ 371 Date: May 5, 2014

(51) Int. Cl. G06F 3/01

(52) U.S. Cl. CPC G06F 3/017
USPC 345/156

(57) ABSTRACT

Examples disclose a device with a sensor to detect a location of a chassis which does not include an input component for a hand gesture and to execute an input command on the device based on the hand gesture and if the hand gesture is detected at the location of the chassis which does not include the input component.

### BACKGROUND

When interacting with a user interface rendered on a device, a user can access an input component of the device, such as a keyboard and/or a mouse. The user can reposition the mouse from one location to another to navigate the user interface and to access visual content rendered on the user interface. In another example, the user can utilize shortcut keys on the keyboard to access and/or navigate between visual content on the user interface.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device according to an example.

FIG. 2A and FIG. 2B illustrate a chassis of a device and a sensor to detect a hand gesture from a user according to an example.

FIG. 3 illustrates a block diagram of an input application identifying an input command for a device according to an example.

FIG. 4 is a flow chart illustrating a method for detecting an input for a device according to an example.

FIG. 5 is a flow chart illustrating a method for detecting an input for a device according to another example.

### DETAILED DESCRIPTION

A device includes a sensor and a chassis with an input component of the device. The chassis can be a frame, enclosure, and/or casing of the device. The input component can be a touchpad or a keyboard which is not located at one or more locations of the chassis, such as an edge of the chassis. The sensor can be a touch sensor, a proximity sensor, a touch surface, and/or an image capture component which can detect information of a hand gesture from a user of the device. In response to detecting information of the hand gesture, the device can determine whether the hand gesture is made at a location of the chassis which does not include the input component. If the hand gesture is detected at a location of the chassis not including the input component, the device can identify and execute an input command for the device based on information of the hand gesture. An input command can be an input instruction of the device to access and/or navigate the user interface.

In one embodiment, the input command can be identified to be a hand gesture command to navigate between content of a user interface of the device if the hand gesture is detected at a location of the chassis not including the input component. The content can include an application, file, media, menu, setting, and/or wallpaper of the device. In another embodiment, if the input component is accessed by the hand gesture, the device will identify an input command for the device to be a pointer command. A pointer command can be used to access and/or navigate a presently rendered content of the user interface. By detecting a hand gesture and determining if the hand gesture is made at a location of the chassis not including the input component, the device can accurately identify one or more input commands on the device for a user to access and navigate a user interface with one or more hand gestures.

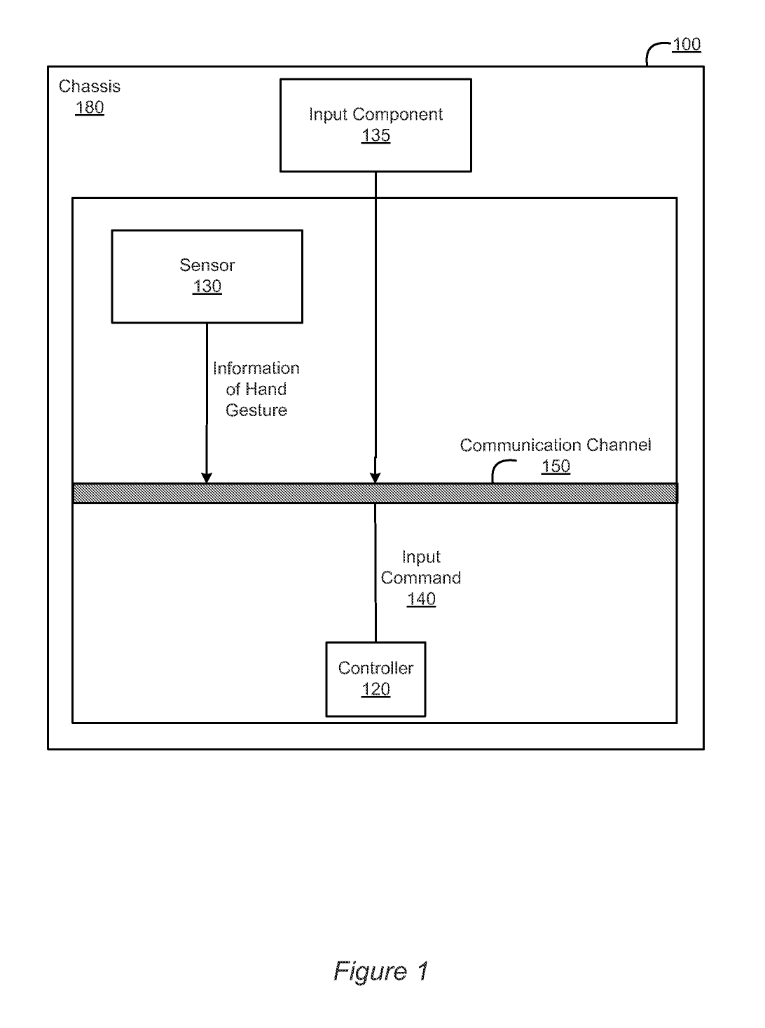

FIG. 1 illustrates a device 100 according to an example. The device 100 can be a laptop, a notebook, a tablet, a netbook, an all-in-one system, and/or a desktop. In another embodiment, the device 100 can be a cellular device, a FDA (Personal Digital Assistant), an E (Electronic)-Reader, and/or any device with a chassis 180, which a user can interact with through a hand gesture. The device 100 includes a chassis 105, a controller 120, an input component 135, a sensor 130, and a communication channel 150 for components of the device 100 to communicate with one another. In one embodiment, the device 100 includes an input application which can be utilized independently and/or in conjunction with the controller 120 to manage the device 100. The input application can be a firmware or application executable by the controller 120 from a non-transitory computer readable memory of the device 100.

A user can interact with the device 100 by making one or more hand gestures at a location of the chassis 180 for a sensor 130 of the device 100 to detect. For the purposes of this application, a chassis 180 includes a frame, an enclosure, and/or a casing of the device 100. The chassis 180 includes one or more locations which do not include an input component 135 of the device 100. The input component 135 is hardware component of the device 100, such as a touchpad and/or a keyboard. For the purposes of this application, a location of the chassis 180 not including the input component 135 includes a space and/or portion of the chassis 180, such as an edge of the chassis 180, where the input component 135 is not located. One or more edges can include a top edge, a bottom edge, a left edge, and/or a right edge of the chassis 180. In one embodiment, the chassis 180 includes a top portion and a bottom portion. Both the top portion and the bottom portion of the chassis 180 can include one or more corresponding locations which do not include the input component 135.

The sensor 130 is a hardware component of the device 100 which can detect one or more locations of the chassis 180 not including the input component 135 for a hand or finger of the user as the user is making one or more hand gestures to interact with the device 100. In one embodiment, the sensor 130 can be a touch surface or proximity sensor of the device 100 included at a corresponding location of the chassis 180 not including the input component 135. In other embodiments, the sensor 130 can be an image capture component which can capture a view of a hand gesture accessing of one or more of the corresponding locations of the chassis 180. For the purposes of this application, a hand gesture includes a finger and/or a hand of the user touching or coming within proximity of a location of the chassis 180. In another embodiment, a hand gesture can include the user making a motion with at least one finger and/or a hand when touching or when within proximity of a location of the chassis 180.

When detecting the hand gesture, the sensor 130 can detect information of the hand gesture. The information can include one or more coordinates corresponding to accessed locations of the chassis 280 and/or accessed locations of the sensor 130. Using the detected information of the accessed locations, the controller 120 and/or the input application can determine whether the hand gesture is detected at a location of the chassis 180 not including the input component 135. Additionally, using the detected information of the accessed locations, the controller 120 and/or the input application can determine if the hand gesture includes a motion and a direction of the motion.

The sensor 130 can pass information of the detected hand gesture to the controller 120 and/or the input application. The controller 120 and/or the input application can use the information to determine whether the hand gesture is detected at a corresponding location of the chassis 180 which does not include the input component 135. In one embodiment, if the sensor 130 is a touch surface or proximity sensor located at a location of the chassis 180 not including the input component 135, the controller 120 and/or the input application determine that the hand gesture is detected at a location of the chassis 180 not including the input component 135 in response to receiving any information of a hand gesture from the sensor 130. In another embodiment, the controller 120 and/or the input application can compare coordinates of the accessed location to predefined coordinates corresponding to locations of the chassis 180 not including the input component 135. If a match is found, the controller 120 and/or the input application determine that the hand gesture has been detected at a location of the chassis 180 not including the input component 135.

If the hand gesture is detected at a location of the chassis 180 not including the input component 135, the controller 120 and/or the input application proceed to identify an input command 140 to be a hand gesture command. For the purposes of this application, an input command 140 includes an input instruction to access and/or navigate the user interface. A hand gesture command can be an instruction to navigate between content of a user interface of the device 100. When identifying a corresponding hand gesture command, the controller 120 and/or the input application compare the information of the hand gesture to predefined information of hand gesture commands, If the detected information matches a corresponding hand gesture command, the input command 140 will have been identified and the controller 120 and/or the input application can execute the input command 140 on the device 100.

In another embodiment, if a location of the chassis 180 which does not include the input component 135 has not been accessed, the controller 120 and/or the input application can determine if the input component 135 has been accessed. The user can access the input component 135 by making a hand gesture at the input component 135. If the input component 135 is accessed, the controller 120 and/or the input application can determine that an input command 140 for the device 100 is not a hand gesture command. In one embodiment, if the touchpad is accessed, the controller 120 and/or the input application determine that the input command 140 is a pointer command to access and to navigate a presently rendered content on the user interface. In another embodiment, if the keyboard is accessed, the controller 120 and/or the input application can identify a corresponding alphanumeric input corresponding to key of the keyboard accessed by the user.

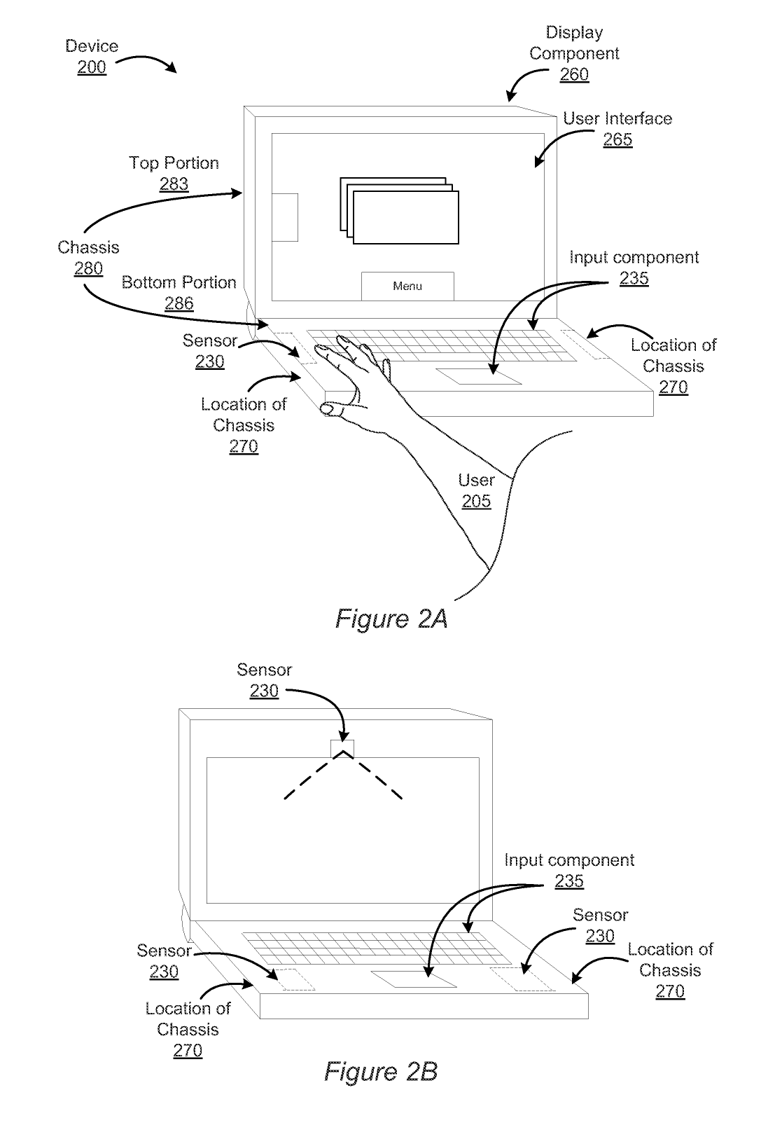

FIG. 2A and FIG. 2B illustrate a chassis 280 of a device 200 and a sensor 230 to detect a hand gesture from a user 205 according to an example. The user 205 can be any person which can access the device 200 through one or more hand gestures. The chassis 280 can be a frame, an enclosure, and/or a casing to house one or more components of the device 200. In one embodiment, a composition of the chassis 280 can include an alloy, a plastic, a carbon fiber, a fiberglass, and/or any additional element or a combination of elements in addition to and/or in lieu of those noted above. As shown in FIG. 2A, the chassis 280 includes one or more corresponding locations 270 which do not include an input component 235 of the device 200. As noted above, a location 270 of the chassis 280 which does not including the input component 235 includes a space and/or portion of the chassis 280, such as an edge of the chassis 280, where the input component 235 is not located.

In one embodiment, a location 270 of the chassis 280 not including the input component 235 includes an edge of the chassis 280. One or more edges include a top edge, a bottom edge, a right edge, and/or a left edge of the chassis 280. Additionally, as shown in FIG. 2A, one or more of the corresponding locations 270 can include visible markings to display where on the chassis 280 the corresponding locations 270 are included. A visible marking can be a visible printing on the surface of the chassis 280. In another embodiment, a visible marking can include crevices or locations on the surface of the chassis 280 which are illuminated from a light source of the device 200. In other embodiments, a visible marking can be any additional visible object which can be used to indicate a corresponding location of the chassis 280 not including the input component 235.

The chassis 280 can include a top portion and a bottom portion. Both the top portion and the bottom portion can include corresponding locations 270 which do not include an input component 235. In one embodiment, a corresponding location 270 of the bottom portion of the chassis 280 not including the input component 235 can be above, below, to the left, and/or to the right of the input component 235. The input component 235 can be housed in the bottom portion of the chassis 280. For the purposes of this application, an input component 235 is a hardware component of the device 200, such as a touchpad or a keyboard which a user 205 can access for non-hand gesture commands.

Additionally, the top portion of the chassis 280 can house a display component 260 of the device. The display component 260 is a hardware output component which can display visual content on a user interface 265 for a user 205 of the device 200 to view and/or interact with. In one embodiment, the display component 260 is a LCD (liquid crystal display), a LED (light emitting diode) display, a CRT (cathode ray tube) display, a plasma display, a projector and/or any additional device configured to display the user interface 265 to include visual content. The visual content can include a file, an application, a document, media, a menu, a sub-menu, and/or wallpaper of the device 200.

As shown in FIG. 2A, the device 200 can include one or more sensors 230 to detect for a hand gesture at corresponding locations 270 of the chassis 280 not including the input component 235. For the purposes of this application, the sensor 230 is a hardware component of the device 200 which can detect information of a hand gesture from the user 205. In one embodiment, the sensor 230 can be coupled to or integrated at a single location 270 of the chassis 280, such as an edge of the chassis 280, adjacent to a keyboard of the device 200. In another embodiment, the device 200 can include more than one sensor 230 located at different locations 270 of the chassis 280 not including an input component 235. The sensor 230 can include a touch sensor, a touch surface, a proximity sensor, and/or any additional hardware component which can detect information of a hand gesture touching and/or coming within proximity of a location 270 of the chassis 280 not including the input component 235.

In another embodiment, as illustrated in FIG. 2B, one or more locations 235 of the chassis 280 which do not include an input component 235 include an area or spacing between an edge of the chassis 280 and the input component 235. As shown in the present embodiment, a corresponding location 270 of the chassis 280 not including the input component 235 is to the side of a touchpad component of the device 200 and does not reach an edge of the chassis 280. In other embodiments, one or more sensors 230 can include an image capture component which can be coupled to a top portion of the chassis 280. The image capture component can capture a view of the corresponding locations 270 of the bottom portion to detect a hand gesture from the user 205.

As a user 205 accesses a corresponding location 270 of the chassis 280 with a hand gesture, the sensor 230 can detect information of the hand gesture. The user 205 can use a finger and/or hand to make a hand gesture by touching or coming within proximity of the chassis 280. The sensor 230 can detect information of the hand gesture from the user 205 by detecting locations 270 of the chassis 280 not including the input component 235 for the hand gesture. In one embodiment, the information can include coordinates of the chassis 280 or coordinates of the sensor 230 accessed by the hand gesture. The sensor 230 can share the detected information of the hand gesture with a controller and/or an input application of the device 200. In response to receiving detected information of the hand gesture, the controller and/or the input application can identify an input command for the device 200.

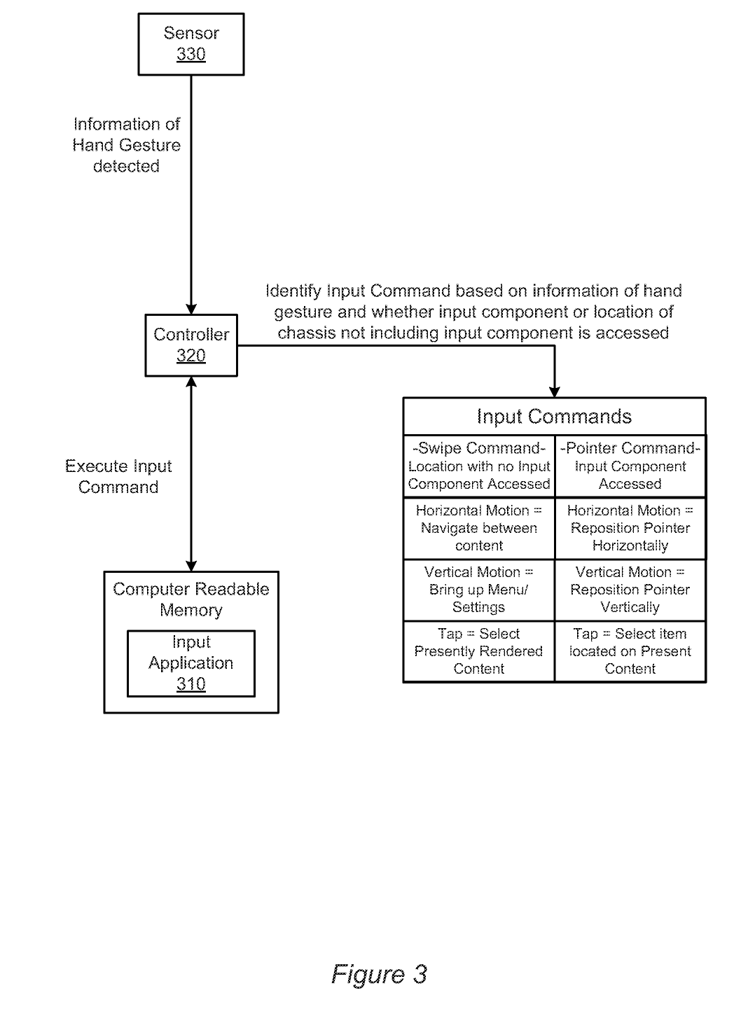

FIG. 3 illustrates a block diagram of an input application 310 identifying an input command for a device according to an example. In one embodiment, the input application 310 can be a firmware embedded onto one or more components of the device. In another embodiment, the input application 310 can be an application accessible from a non-volatile computer readable memory of the device. The computer readable memory is a tangible apparatus that contains, stores, communicates, or transports the application for use by or in connection with the device, hi one embodiment, the computer readable memory is a hard drive, a compact disc, a flash disk, a network drive or any other form of tangible apparatus coupled to the device.

As shown in FIG. 3, the sensor 330 has detected information of a hand gesture from a user. In one embodiment, the information includes locations of the chassis which the hand gesture was detected. In another embodiment, if the sensor 330 is included at a location of the chassis not including a input component, the information can include locations of the sensor 330 which were accessed by the hand gesture. The locations of the chassis and/or sensor 330 can be shared by the sensor 330 as coordinates of the chassis or sensor 330. Using the detected information of the hand gesture, the controller 320 and/or the input application 310 can identify an input command based on information of the detected hand gesture.

In one embodiment, the controller 320 and/or the input application 310 can initially access a list, table, and/or database of input commands and compare the detected information of the hand gesture to predefined information corresponding to input commands of the device. The list, table, and/or database of input commands can be locally stored on the device or remotely accessed from another device. As shown in the present embodiment, the list, table, and/or database of input commands can include one or more hand gesture commands and one or more pointer commands. A hand gesture command can be used to navigate between content of the user interface. A pointer command can be used to access and/or navigate a presently rendered content of the user interface. In other embodiments, the device can include additional input commands in addition to and/or in lieu of those noted above and illustrated in FIG. 3.

If the controller 320 and/or the input application 310 determine that the hand gesture is detected at a location of the chassis not including the input component, such as an edge of the chassis, the input command will be identified to be a hand gesture command. The controller 320 and/or the input application 310 can determine that the hand gesture is detected at a location of the chassis not including the input component, if the sensor 330 is included at an edge of the chassis and the sensor 330 has been accessed with a hand gesture.

In another embodiment, if the sensor 330 is an image capture component which captures a view of the edges, the controller 320 and/or the input application 310 compare accessed locations of the chassis to predefined coordinates corresponding to locations of the chassis not including the input component. If any of the accessed locations match a predefined coordinate corresponding to locations of the chassis not including the input component, the controller 320 and/or the input application 310 determine that an edge of the chassis has been accessed by the hand gesture. The predefined coordinates of the locations of the chassis can be defined by the controller 320, the input application 310, a user, and/or a manufacturer of the device.

In response to determining that a location of the chassis not including the input component has been accessed by a hand gesture, the controller 320 and/or the input application 310 proceed to access the list of hand gesture commands and compare the information of the hand gesture to predefined information of each hand gesture command. If a match is found, the controller 320 and/or the input application 310 proceed to execute the identified hand gesture command on the device.

In one embodiment, if the detected information of the hand gesture specifies that the hand gesture include a horizontal motion at the edge of the chassis, the controller 320 and/or the input application 310 identify the input command to be a hand gesture command to navigate between content of the user interface. In another embodiment, if the detected information of the hand gesture specifies that the hand gesture include a vertical motion at the edge of the chassis, the controller 320 and/or the input application 310 identify the input command to be a hand gesture command to bring up a menu or settings. The menu or settings can correspond to a content which is currently rendered on the user interface or the menu or settings can correspond to a menu or settings of an operating system of the device. As the menu or settings is rendered on the user interface, the user can make one or more additional hand gestures to navigate the menu or settings. Additionally, the user can make one or more additional hand gestures to select an item of the menu or settings or to bring up a sub-menu.

In another embodiment, if the controller 320 and/or the input application 310 determine that the hand gesture is not detected a location of the chassis not including the input component, the controller 320 and/or the input application 310 determine if the input component has been accessed. As noted above, the input component can be a keyboard and/or a touchpad of the device, If the touchpad is accessed, the controller 320 and/or the input application 310 determine that the input command for the device is a pointer command. The controller 320 and/or the input application 310 can then determine which pointer command to execute based on information of the hand gesture.

If the detected information specifies that the hand gesture includes a horizontal motion with the input component, the controller 320 and/or the input application 310 identify the input command to be a pointer command to reposition a pointer horizontally. In another embodiment, if the detected information specifies that the hand gesture include a vertical motion using the input component, the input command is identified to be a pointer command to reposition the pointer vertically. If the input component is a keyboard, the controller 320 and/or the input application 310 can identify the input command to be a keyboard entry and identify which alphanumeric input to process based on which key of the keyboard was accessed.

In other embodiments, the controller 320 and/or the input application 310 can additionally consider which location of the chassis not including the input component was accessed when identifying an input command. The controller 320, the input application 310, and/or the user of the device can define which location of the chassis can be used for a hand gesture command and which location of the chassis can be used for a pointer command.

In one embodiment, a first edge of the chassis can be used for a hand gesture command, while a second edge of the chassis can be used for a pointer command. For example, if a right edge of the chassis is accessed by the hand gesture, the controller 320 and/or the input application 310 can identify the input command to be a hand gesture command. Additionally, if a left edge of the chassis, opposite to the right edge, is accessed by the hand gesture, the controller 320 and/or the input application can identify the input command to be a pointer command. The controller 320 and/or the input application 310 can then proceed to identify and execute a corresponding input command based on information of the hand gesture.

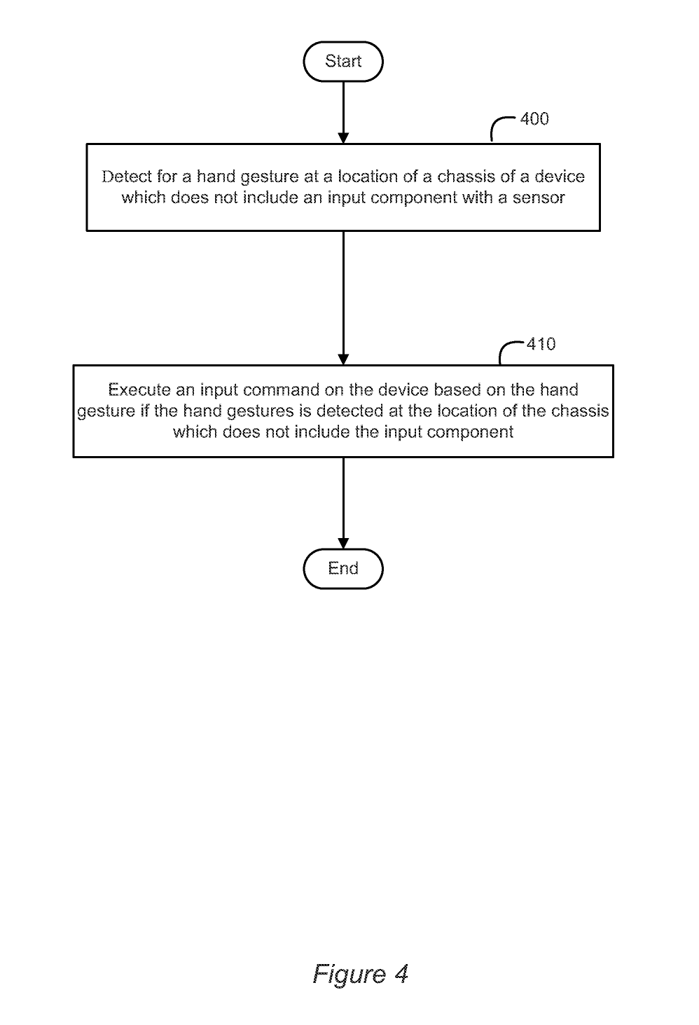

FIG. 4 is a flow chart illustrating a method for detecting an input for a device according to an example. A controller and/or input application can be utilized independently and/or in conjunction with one another to identify an input command of the device. A sensor of device, such as a touch sensor, touch surface, and/or proximity sensor can initially detect information of a hand gesture made at a location of the chassis which does not include an input component 400. The chassis can be a frame, enclosure, and/or casing of the device which houses the input component. The chassis includes one or more locations, such as an edge of the chassis, which the input component is not included and/or is not located.

If the sensor detects a hand gesture, the sensor can pass information of a hand gesture, such as locations of accessed locations of the chassis for the controller and/or the input application to identify an input command of the device. The controller and/or the input application can use the detected information of the hand gesture to determine if the hand gesture is made at a location of the chassis not including the input component. If the controller and/or the input application determine that the hand gesture is made at a corresponding location of the chassis, the controller and/or the input application can proceed to execute an input command, such as a hand gesture command, on the device based on information of the hand gesture at 410.

In another embodiment, if the hand gesture is not detected at a location of the chassis not including the input component, the controller and/or the input application can determine if the hand gesture accesses an input component, such as a touchpad or keyboard. If the input component is accessed, the controller and/or the input application can identify and execute a corresponding pointer command based on information of the hand gesture. The method is then complete. In other embodiments, the method of FIG. 4 includes additional steps in addition to and/or in lieu of those depicted in FIG. 4.

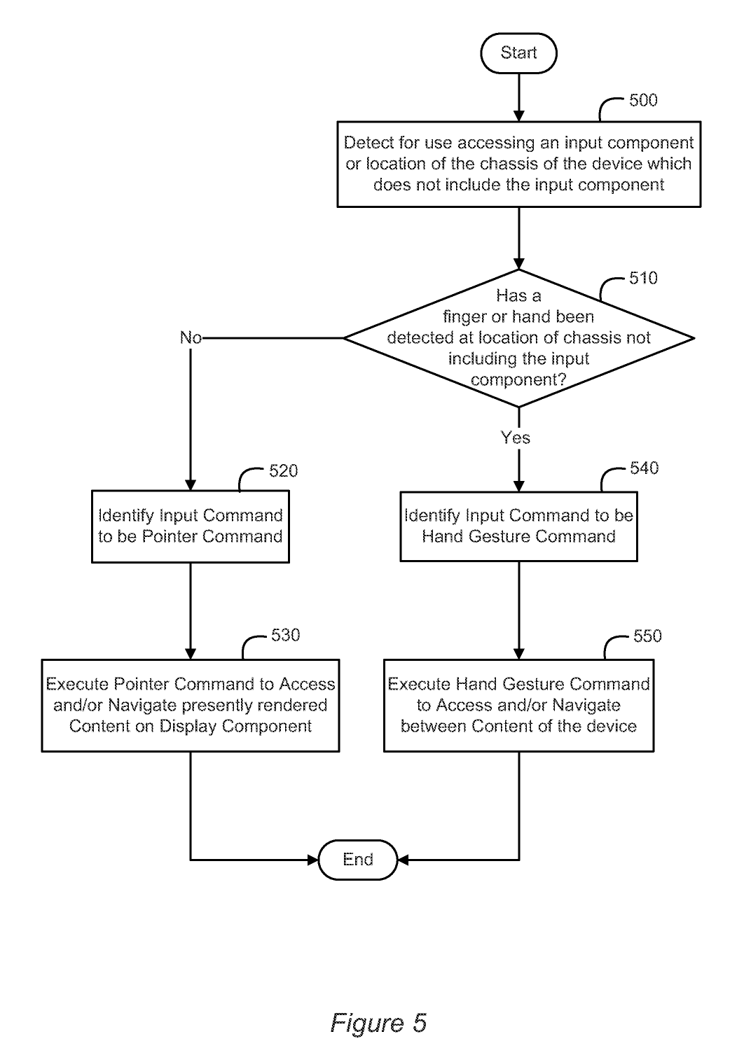

FIG. 5 is a flow chart illustrating a method for detecting an input for a device according to an example. The controller and/or the input application use a sensor of the device to detect information of a hand gesture accessing an input component or a location of a chassis which does not include an input component at 500. As noted above, the corresponding locations of the chassis can include visual markings to display where they are located on the chassis. The controller and/or the input application can use the detected information to determine if the finger or hand of the hand gesture are touching or within proximity of a corresponding location of the chassis not including the input component at 510.

In one embodiment, if the sensor is located at a corresponding location of the chassis not including the input component, the controller and/or the input application determine that a hand gesture is detected at the corresponding location in response to the sensor detecting a hand gesture. In another embodiment, if the sensor is an image capture component which captures a view of the corresponding locations, the controller and/or the input application can compare accessed locations of the hand gesture to predefined coordinates corresponding to locations of the chassis not including the input component. If any of the accessed locations match a predefined coordinate, the controller and/or the input application determine that a location of the chassis not including the input component has been accessed by the hand gesture.

If a corresponding location of the chassis not including the hand gesture is determined to not be accessed, the controller and/or the input application determine if input component has been accessed. If the input component is accessed by the hand gesture, the input command is identified to be a pointer command at 520. In one embodiment, the controller and/or the input application can access a list, table, and/or database of input commands and compare the detected information of the hand gesture to predefined information of pointer commands. If a match is found, the controller and/or the input application can proceed to execute the corresponding pointer command to access and/or navigate presently rendered content on the device at 530.

If the hand gesture is detected at a corresponding location of the chassis not including the input component, the controller and/or the input application identify the input command to be a hand gesture command at 540. The controller and/or the input application access the list, table, and/or database of input commands and compare the detected information of the hand gesture to predefined information of hand gesture commands. If a match is found, the controller and/or the input application proceed to execute the corresponding hand gesture command to navigate between content of the device at 550. The method is then complete. In other embodiments, the method of FIG. 5 includes additional steps in addition to and/or in lieu of those depicted in FIG. 5.

What is claimed is:

1. A device comprising:
a chassis to include an input component;
a sensor to detect for a hand gesture at a location of the chassis which does not include the input component; and
a controller to execute an input command on the device based on the hand gesture if the hand gesture is detected at the location of the chassis which does not include the input component.

2. The device of claim 1 wherein the input component includes at least one of a keyboard and a touchpad of the device.

3. The device of claim 1 wherein the location of the chassis which does not include the input component includes an edge of the chassis.

4. The device of claim 1 wherein the location of the chassis which does not include the input component includes at least one portion of the chassis between an edge of the chassis and the input component.

5. The device of claim 1 wherein the sensor includes at least one of a touch sensor, a touch surface, and a proximity sensor located at an edge of the chassis.

6. The device of claim 1 wherein the sensor is an image capture component which captures a view of the edges of the chassis.

7. The device of claim 6 wherein the chassis includes a top portion to include the sensor and a bottom portion to include the input component.

8. A method for detecting an input for a device comprising:
detecting for a hand gesture at a location of a chassis of a device which does not include an input component with a sensor; and
executing an input command on the device based on the hand gesture if the hand gestures is detected at the location of the chassis which does not include the input component.

9. The method for detecting an input for a device of claim 8 wherein detecting a hand gesture at an edge includes detecting an edge of the chassis for a hand gesture.

10. The method for detecting an input for a device of claim 8 further comprising detecting for a hand gesture accessing the input component

11. The method for detecting an input for a device of claim 10 further comprising determining whether the input command is a hand gesture command or a pointer command.

12. The method for detecting an input for a device of claim 11 wherein the input command is identified to be a hand gesture command to navigate between content of the device if the hand gesture is detected at an edge of the device.

13. The method for detecting an input for a device of claim 11 wherein the input command is identified to be a pointer command to navigate a presently rendered content of the device if the input component detects a hand gesture.

14. A computer readable medium comprising instructions that if executed cause a controller to:
detect a location of a chassis of a device which does not include an input component for a hand gesture with a sensor; and
execute an input command on the device based on the hand gesture if the hand gesture is detected at the location of the chassis which does not include the input component.

15. The computer readable medium of claim 14 wherein the controller additionally identifies the input command to be a hand gesture command if the hand gesture is detected at a first edge of the chassis and the input command is identified to be a pointer command if the hand gesture is detected at a second edge of the chassis.
